(19) United States
(12) Patent Application Publication
(10) Pub. No.: US 2007/0222809 A1
(43) Pub. Date: Sep. 27, 2007

(54) DROPLET JET INSPECTING DEVICE, DROPLET JETTING APPLICATOR AND METHOD FOR MANUFACTURING COATED BODY

(75) Inventors: Kenichi Ooshiro, Yokohama-shi (JP); Tsuyoshi Sato, Yokohama-shi (JP); Yasuhiko Sawada, Yokohama-shi (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Kabushiki Kaisha Toshiba, Minato-ku (JP)

(21) Appl. No.: 11/535,319

(22) Filed: Sep. 26, 2006

(30) Foreign Application Priority Data
Mar. 22, 2006 (JP) 2006-078658

(51) Int. Cl. B41J 29/393

(52) U.S. Cl. 347/19

(57) ABSTRACT

A droplet jet inspecting device includes an image pickup part taking an image of an inspection area including an area where a droplet jetted from a droplet jetting head jetting the droplet through a nozzle and a unit configured to process the image of the inspection area taken by the image pickup part and further judge a presence of a satellite droplet which is smaller than a main droplet forming the droplet and which is incidental to the main droplet.

### CROSS REFERENCE OF THE RELATED APPLICATION

This application is based on and claims the benefit of priority from the prior Japanese Patent Application No. 2006-78658, filed on Mar. 22, 2006; the entire content of which are incorporated herein by reference.

### BACKGROUND OF THE INVENTION

1. Field of the Invention

The present invention relates to a droplet jet inspecting device for inspecting an abnormal spotting of droplets, a droplet jetting applicator equipped with the droplet jet inspecting device and a method for manufacturing a coated body.

2. Discussion of the Background

Generally, an ink-jet type droplet jetting applicator is utilized to manufacture a liquid crystal display unit, an organic EL (Electro Luminescence) unit, an electron emission unit, a plasma display unit, an electrophoretic display unit and so on.

This droplet jetting applicator is equipped with droplet jetting heads (e.g. ink-jet heads) for jetting droplets through a plurality of nozzles. By the droplet jetting heads, droplets are landed on an objected to coated, so that a designated pattern of dot rows are formed thereon. For instance, in a manufacturing process for a liquid crystal display unit, a droplet jetting applicator is used to apply respective inks of R (red), G (green) and B (blue) on a transparent substrate in the form of dots, in sequence, producing a color filter where dots of respective colors are arranged in sequence.

In the droplet jetting applicator like this, there is a possibility that, after jetting a main droplet forming the droplet, a nozzle jets a minute droplet which is smaller and slower than the main droplet, namely, a satellite droplet. Due to its time delay and minuteness in comparison with the main droplet, the satellite droplet is likely to be scattered and spotted in other areas outside a designated pattern form. Therefore, if such a satellite droplet has a damaging effect on the designated pattern form, then a display unit (e.g. liquid crystal display unit, organic EL unit, etc.) deteriorates in terms of displaying function etc.

As one method for detecting an occurrence of satellites, there is proposed a technique of sequentially changing a voltage impressed on a droplet jetting head, sequentially taking an image of flying droplets with respect to plural nozzles in sequence and detecting an occurrence of satellites from the image (e.g. see JP-A 2005-14216(KOKAI)).

However, the above technique has a problem of long inspection time since the droplets are jetted with respect to plural nozzles, while the droplets in flight are taken (picturized) in sequence. Additionally, due to its shooting of the droplets in flight, it is difficult to detect the spotting positions of each droplet (main droplet and satellite droplet) on a coated body, accurately.

### SUMMARY OF THE INVENTION

In the above-mentioned situation, it is an object of the present invention to provide a droplet jet inspecting device, a droplet jetting applicator and a method for manufacturing a coated body, all of which can detect an occurrence of an incidental droplet (satellite droplet) in a short time and a spotting position of a droplet on an object to be coated, accurately.

In order to attain the above object, according to a first aspect of embodiments of the present invention, there is provided a droplet jet inspecting device, which includes an image pickup part taking an image of an inspection area including an area where a droplet jetted from a droplet jetting head jetting the droplet through a nozzle; and a unit configured to process the image of the inspection area taken by the image pickup part and further judge a presence of a satellite droplet which is smaller than a main droplet forming the droplet and which is incidental to the main droplet.

According to a second aspect of embodiments of the present invention, there is also provided a droplet jetting applicator, which includes a droplet jetting head jetting the droplet through a nozzle; and a droplet jet inspecting device, wherein the droplet jet inspecting device includes an image pickup part taking an image of an inspection area including an area where a droplet jetted from the droplet jetting head; and a unit configured to process the image of the inspection area taken by the image pickup part and further judge a presence of a satellite droplet which is smaller than a main droplet forming the droplet and which is incidental to the main droplet.

According to a third aspect of embodiments of the present invention, there is also provided a method for manufacturing a coated body, which includes jetting a droplet to an object to be coated, by a droplet jetting head, the droplet jetting head having a piezoelectric element and being adapted so as to jet the droplet through a nozzle by driving the piezoelectric element; detecting a presence of a satellite droplet which is incidental to a main droplet forming the droplet; and adjusting a voltage impressed on the piezoelectric element when the presence of the satellite droplet is detected and subsequently jetting a droplet to the object again.

### BRIEF DESCRIPTION OF THE DRAWINGS

FIG. 1 is a perspective view showing a schematic structure of a droplet jetting applicator in accordance with a first embodiment of the present invention;

FIG. 2 is a sectional view showing a schematic structure of a droplet jetting head of the droplet jetting applicator of FIG. 1;

FIG. 3 is a lateral view showing a schematic structure of a droplet jet inspecting device of the droplet jetting applicator of FIG. 1;

FIG. 4 is a plan view showing an inspection substrate after droplets are spotted, on a mount table of the droplet jet inspecting device of FIG. 3;

FIG. 5 is a flow chart showing a flow of an inspecting process by the droplet jet inspecting device of FIG. 3;

FIG. 6 is an explanatory diagram for explanation of a relationship between an impressed voltage and the number of satellites; and

FIG. 7 is a flow chart showing a flow of an inspecting process by a droplet jet inspecting device in a droplet jetting applicator in accordance with a second embodiment of the present invention.

### DETAILED DESCRIPTION OF THE INVENTION

### 1^{st}. Embodiment

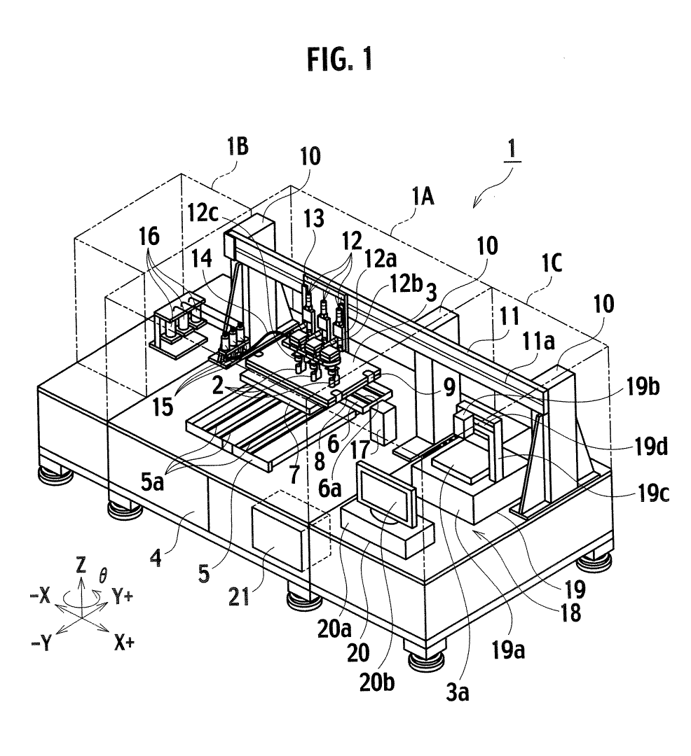

The first embodiment of the present invention will be described with reference to FIGS. 1 to 6.

As shown in FIG. 1, a droplet jetting applicator 1 comprises an ink applicator box 1A for applying ink on a substrate 3 (i.e. an object to be coated) with the use of droplet jetting heads (ink-jet head) 2 jetting ink droplets E through nozzles, an ink supply box 1B for supplying the ink applicator box 1A with ink and a droplet jet inspecting box 1C for inspecting an abnormal spotting of the droplets E of the droplet jetting heads 2. The ink applicator box 1A, the ink supply box 1B and the droplet jet inspecting box 1C are situated next to each other and together fixed on a top surface of a frame 4.

In the ink applicator box 1A, there are successively stacked a Y-axis direction slide plate 5, a Y-axis direction moving table 6, an X-axis direction slide plate 7 and an X-axis direction moving table 8. The Y-axis direction slide plate 5, the Y-axis direction moving table 6, the X-axis direction slide plate 7 and the X-axis direction moving table 8 are formed to be flat plates respectively.

The Y-axis direction slide plate 5 is fixed on the top surface of the frame 4. The Y-axis direction slide plate 5 is provided, on its top surface, with a plurality of guide grooves 5a along a direction of Y-axis. Engaged in the guide grooves 5a are guide projections (not shown) which are formed on a lower surface of the Y-axis direction moving table 6. Consequently, the Y-axis direction moving table 6 is arranged on the top surface of the Y-axis direction slide plate 5 so as to be movable along the direction of Y-axis. The Y-axis direction moving table 6 is moved in the direction of Y-axis along the guide grooves 5a by a drive mechanism using a Y-axis direction moving motor (not shown).

The Y-axis direction moving table 6 is provided, on its top surface, with a plurality of guide grooves 6a along a direction of X-axis. Engaged in the guide grooves 6a are guide projections (not shown) which are formed on a lower surface of the X-axis direction moving table 7. Consequently, the X-axis direction moving table 7 is arranged on the top surface of the Y-axis direction moving table 6 so as to be movable along the direction of X-axis. The X-axis direction moving table 7 is moved in the direction of Y-axis along the guide grooves 6a by a drive mechanism using an X-axis direction moving motor (not shown).

A substrate carrier table 8 for holding the substrate 3 is fixed on a top surface of the X-axis direction moving table 7. The substrate carrier table 8 is provided with a substrate gripping mechanism 9 for gripping the substrate 3. Thus, the substrate 3 is tightly fixed on the substrate carrier table 8 by the substrate gripping mechanism 9. The substrate gripping mechanism 9 is formed by, for instance, U-shaped nipping tools. Note that as holding means for holding the substrate 3, a substrate absorbing mechanism for absorbing the substrate 3 may be provided in place of the substrate gripping mechanism 9. For example, rubber suction cups, a suction pump or the like may be adopted for the substrate gripping mechanism 9.

Here, a moving distance of the substrate carrier table 8 in the direction of X-axis is detected on the basis of pulse signals outputted from an X-axis direction encoder (not shown), while a moving distance of the substrate carrier table 8 in the direction of Y-axis is detected on the basis of pulse signals outputted from a Y-axis direction encoder (not shown).

In the ink applicator box 1A, two columns (supporting braces) 10 are arranged to stand upright. In the droplet jet inspecting box 1C, additionally, a single column 10 is arranged so as to stand upright. The columns 10 in the ink applicator box 1A are arranged so as to interpose the Y-axis direction slide plate 5 in a perpendicular direction to the guide grooves 5a, that is, in the direction of X-axis. While, the column 10 in the droplet jet inspecting box 1C is arranged in alignment with the two columns mentioned above.

An X-axis slide plate 11 is arranged to lay across these columns 10 laterally. The X-axis slide plate 11 is provided, on its front surface, with a guide groove 11a extending in the direction of X-axis. A plurality of ink-jet head units 12 having the droplet jetting heads 2 respectively are arranged so as to hang from a base plate 13. The base plate 13 is provided, on its rear surface, with a guide projection (not shown) that engages with the guide groove 11a of the X-axis slide plate 11. Thus, the base plate 13 is arranged on the X-axis slide plate 11 so as to be movable in the direction of X-axis. The base plate 13 (i.e. the ink-jet head units 12) is moved in the direction of X-axis along the guide groove 11a by a drive mechanism using a head-unit moving motor (not shown).

The droplet jetting heads 2 are attached to leading ends of the ink-jet head units 12, respectively. The droplet jetting heads 2 are supplied with inks from ink tanks 15 through supply pipes 14. The ink tanks 15 are connected to ink supply tanks 16 in the ink supply box 1B and always supplied with inks from the ink supply tanks 16.

Each ink-jet head unit 12 is provided with a Z-axis direction moving mechanism 12a for moving the corresponding droplet jetting head 2 vertically to a surface (upper surface) of the substrate 3, that is, in the direction of Z-axis, a Y-axis direction moving mechanism 12b for moving the corresponding droplet jetting head 2 in the direction of Y-axis and a θ direction rotating mechanism 12c for rotating the corresponding droplet jetting head 2 in the direction of θ. In this way, the droplet jetting heads 2 can move in the directions of Z-axis and Y-axis and also rotate in the direction of θ.

In the ink applicator box 1A, a head maintenance unit 17 is arranged to clean up respective nozzles of the droplet jetting heads 2, which are clogged with inks. The head maintenance unit 17 is positioned on a straight line of the moving direction of the ink-jet head units 12, apart from the substrate 3. In operation, when a certain ink-jet head unit 12 moves to a position opposing the head maintenance unit 17, it begins to clean up a clogged nozzle in the relevant ink-jet head unit 12.

A droplet jet inspecting device 18 is arranged in the droplet jet inspecting box 1C. The droplet jet inspecting device 18 includes an inspection part 19 for inspecting spotting of droplets E jetted from the droplet jetting heads 2 and an inspection control unit 20 for controlling the operation of the inspection part 19. The inspection part 19 picks up an image of each droplet E landing in an inspection substrate 3a as an object to be coated and inspects an occurrence of abnormal spotting. Additionally, the inspection control unit 20 controls the operation of respective parts of the inspection part 19 and allows it to perform the operation of detecting the occurrence of abnormal spotting of each droplet E.

In the frame 4, there is a control part 21 for controlling the droplet jetting applicator 1, mainly, respective parts of the ink applicator box 1A. The control part 21 is electrically connected to the inspection control unit 20, transmitting various signals, such as control signals, to and from the inspection control unit 20.

The control part 21 includes a memory part for storing various kinds of programs and performs various controls in accordance with these programs: moving control of the Y-axis direction moving table 6; moving control of the X-axis direction moving table 7, moving control of the base plate 13; drive control of the Z-axis direction moving mechanism 12a; drive control of the Y-axis direction moving mechanism 12b; drive control of the θ direction rotating mechanism 12c; and so on. Consequently, it is possible to change a position of the substrate 3 carried on the substrate carrier table 8 in relation to the ink-jet head units 12 hung from the base plate 13, variously.

Next, we describe the droplet jetting head 2 in detail.

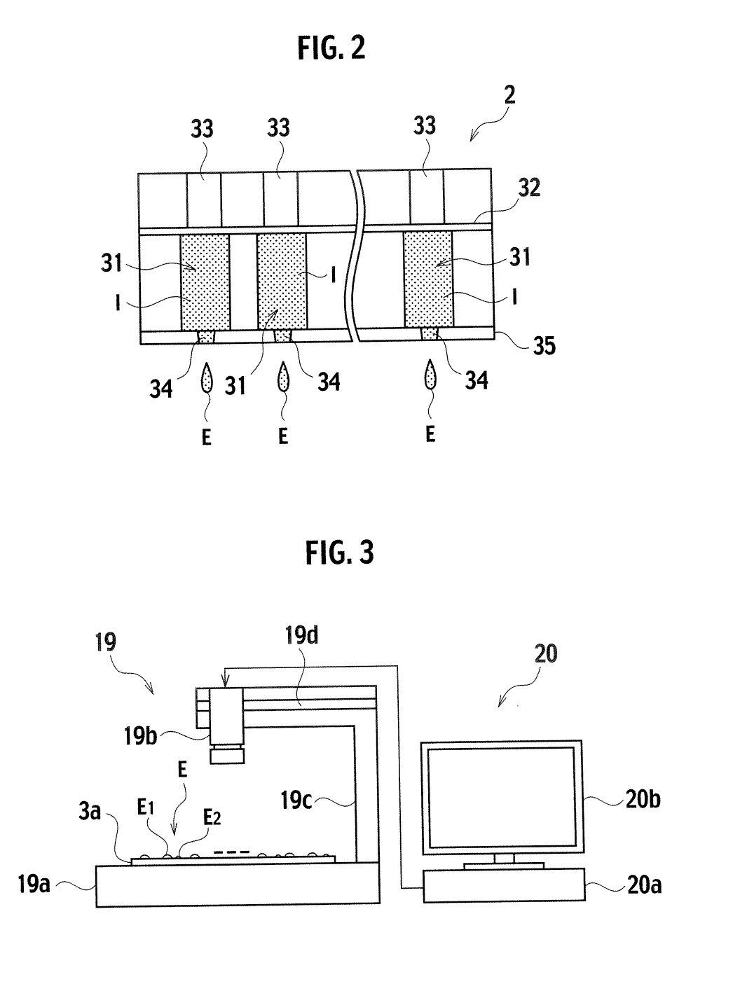

As shown in FIG. 2, the droplet jetting head 2 includes a plurality of ink chambers 31 for accommodating ink I supplied from the ink tanks 15, a diaphragm 32 forming respective walls of the ink chambers 31 partially, a plurality of piezoelectric elements (actuators) 33 corresponding to the respective ink chambers 31 and a nozzle plate 35 having a plurality of nozzles (through-holes) 34 in communication with the ink chambers 31 and forming the respective walls of the ink chambers 31 partially.

The nozzles 34 are positioned in the nozzle plate 35 straightly at regular intervals of a constant pitch. The diaphragm 32 is in the form of a plate. The piezoelectric elements 33 are fixed to the diaphragm 32 adhesively. Since the diaphragm 32 is deformed by driving the piezoelectric elements 33, respective volumes of the ink chambers 31 increase or decrease corresponding to the deformation of the diaphragm 32. Corresponding to increasing and decreasing in the volumes of the ink chambers 31, the ink I in the form of droplets E is ejected from the nozzles 34.

In detail, when a voltage is impressed on the piezoelectric element 33, it shrinks to move the diaphragm 32 upwardly while changing its profile. Then, a pressure in the relevant ink chamber 31 becomes negative, so that the ink I is supplied from the ink tank 15 into the ink chamber 31 through the supply pipe 14. Subsequently, if an impressed voltage on the piezoelectric element 33 becomes zero, then the diaphragm 32 returns to its original state. At this time, the interior of the ink chamber 31 is compressed, so that the ink I is ejected from the nozzle 34, in the form of a droplet E.

Next, the inspection part 19 and the inspection control unit 20 in the droplet jet inspecting device 18 will be described in detail.

As shown in FIG. 3, the inspection part 19 includes a mount table 19a for mounting the inspection substrate 3a as an object to be coated, an image pickup part 19b arranged in a position opposing a spotting surface on the inspection substrate 3a apart from the mount table 19a and a support part 19c that supports the image pickup part 19b so as to be movable horizontally to the mount table 19a.

The mount table 19a is arranged on the frame 4, at a substantial center of the droplet jet inspecting box 1C, to support the inspection substrate 3a on the top surface of the table 19a. An upper surface of the inspection substrate 3a forms a spotting surface for the droplets E. For instance, a glass substrate is available for the inspection substrate 3a.

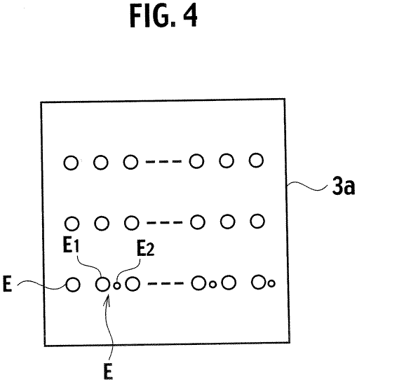

The image pickup part 19b is movably arranged on the support part 19c. This image pickup part 19b has an optical zoom function of switching a focal length between wide-angle and telescope. As shown in FIG. 4, the image pickup part 19b picks up an image of an inspection area including an area that the droplets E ejected from the droplet jetting heads 2 land in. Here, the inspection area corresponds to the spotting surface (upper surface) of the inspection substrate 3a.

The support part 19c is in the form of an arm provided on the mount table 19a. The support part 19c is formed with a guide groove 19d for guiding the image pickup part 19b horizontally to the spotting surface of the inspection substrate 3a, for example, in the direction of X-axis. Engaged in the guide groove 19d is a guide projection (not shown) that is formed on the image pickup part 19b. Consequently, the image pickup part 19b moves along the guide groove 19d in the direction of X-axis.

The inspection control unit 20 includes an inspection control part 20a for controlling the drive of the image pickup part 19b and a display part 20b for displaying various images, for example, an image of spotting surface of the inspection substrate 3a picked up by the image pickup part 19b. The display part 20b is formed by a liquid crystal display, a CRT display, etc.

The inspection control part 20a is electrically connected to the image pickup part 19b and the control part 21 in the frame 4. The inspection control part 20a has a memory part for storing various kinds of programs and performs a variety of processes based on these problems.

For example, the inspection control part 20a controls the operation of the image pickup part 19b and moves it between an image pickup position and a standby position along the guide groove 19d. The image pickup position is a position where the image pickup part 19b opposes a substantial center of the inspection substrate 3a. The standby position is a position where the image pickup part 19b does not inhibit jetting of the respective ink-jet head units 12 against the inspection substrate 3a and where the part 19b does not oppose the substrate 3a.

The inspection control part 20a processes an image of the inspection area picked up by the image pickup part 19b, that is, an image of the spotting surface (see FIG. 4) of the inspection substrate 3a to detect the presence of a satellite droplet E2 which is smaller than a main droplet E1 of the droplets E and which is incidental to the main droplet E1.

We now describe the droplet jetting operation and the inspecting operation of the droplet jetting applicator 1 constructed above. Note that the inspecting operation is carried out either when starting to drive the droplet jetting applicator 1 or periodically, for example, every one hour.

The control part 21 in the frame 4 and the inspection control part 20a of the droplet jet inspecting device 18 execute the droplet jetting operation and the inspecting operation, based on the programs stored in the memory part. Here, the respective ink-jet head units 12 are on stand-to their standby positions opposing the head maintenance unit 17. While, the image pickup part 19b is on stand-to the standby position where the part 19b does not oppose the inspection substrate 3a.

In the droplet jetting operation of the droplet jetting applicator 1, the control part 21 allows the ink-jet head units 12 to move from the standby positions to respective positions opposing the substrate 3. Consequently, the ink-jet head units 12 move to the positions opposing the substrate 3 while being guided by the guide groove 11a of the X-axis direction slide plate 11.

In this state, the control part 21 controls the driving of the Y-axis direction moving table 6 and the X-axis direction moving table 7 and additionally controls the jetting operation of the droplet jetting heads 2 of the ink-jet head units 12. Correspondingly, the droplet jetting heads 2 allow the droplets E to land in the substrate 3 moving in the direction of Y-axis, successively forming a designated pattern of dot rows.

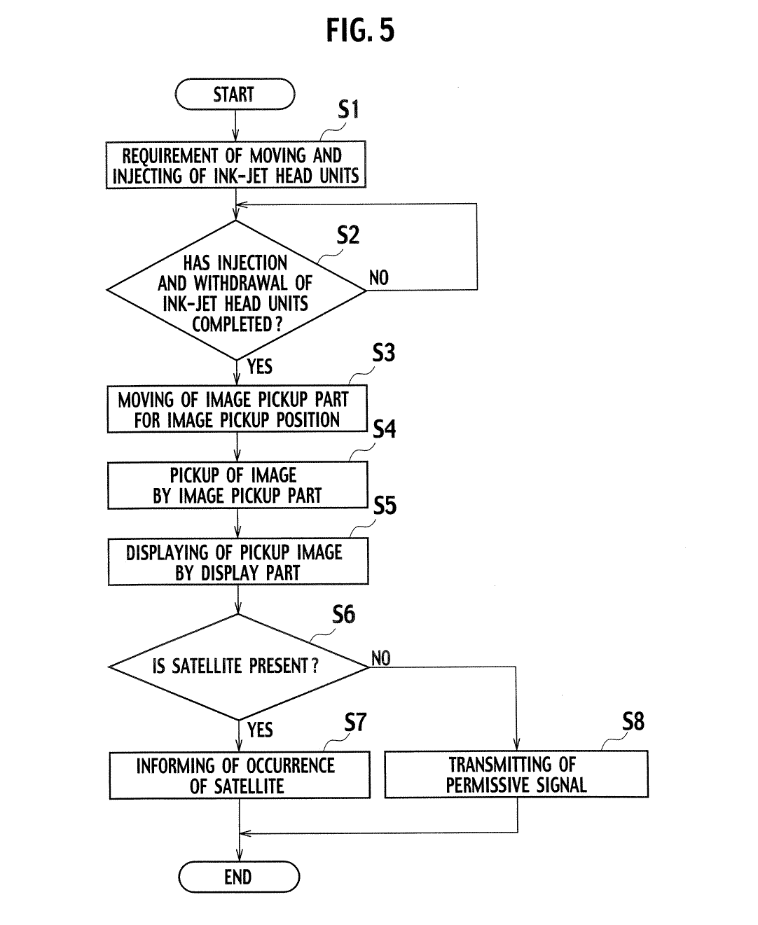

FIG. 5 is a flow chart showing a flow of an inspecting process by the droplet jet inspecting device.

In the inspection of the droplet jetting applicator 1, the inspection control part 20a first moves the ink-jet head units 12 to the positions opposing the inspection substrate 3a on the mount table 19a of the droplet jet inspecting device 18 and further transmits a control signal for jetting the droplets E to the control part 21 (step S1), as shown in FIG. 5. At step S2, it is executed to judge whether both jetting operation and withdrawal movement of the droplet jetting heads 2 of the ink-jet head units 12 have been completed or not. Unless these operations have been completed (No at step S2), it is executed to stand ready to the completion of both jetting operation and withdrawal movement of the droplet jetting heads 2.

We now describe the above jetting operation in detail. Corresponding to the control signal, the control part 21 allows the ink-jet head units 12 to move to the positions opposing the inspection substrate 3a on the mount table 19a of the droplet jet inspecting device 18. Consequently, the ink-jet head units 12 move to the positions opposing the inspection substrate 3a on the mount table 19a while being guided by the guide groove 11a of the X-axis direction slide plate 11.

In this state, the control unit 21 allows the droplet jetting heads 2 of the ink-jet head units 12 to perform the operation of jetting the droplets E. As a result, the droplet jetting heads 2 of the ink-jet head units 12 respectively jet the droplets E against the spotting surface of the inspection substrate 3a through the respective nozzles 34. These droplets E land in the spotting surface of the inspection substrate 3a on the mount table 19a, in the form of dot rows (see FIG. 4).

Subsequently, the control part 21 allows the ink-jet head units 12 to move to the standby positions. Consequently, the ink-jet head units 12 move to the standby positions while being guided by the guide groove 11a of the X-axis direction slide plate 11. Additionally, the control part 21 transmits an information signal for informing the inspection control part 20a of the completion of both jetting operation and withdrawal movement of the ink-jet head units 12 and waits for receiving a permissive signal from the inspection control part 20a.

We now return to the flowchart of FIG. 5. If the inspection control part 20a receives the information signal and judges that both jetting operation and withdrawal movement of the ink-jet head units 12 have been completed (No at step S2), then the routine goes to step S3 where the inspection control part 20a allows the image pickup part 19 to move to the image pickup position. Consequently, the image pickup part 19 moves to the image pickup position opposing the substantial center of the inspection substrate 3a while being guided by the guide groove 19d of the support part 19c.

Subsequently, the inspection control part 20a allows the image pickup part 19 to carry out an image pickup operation (step S4). Correspondingly, the image pickup part 19 takes an image of an inspection area including an area where the droplets E land in, namely, an image of the spotting surface of the inspection substrate 3a.

Next, the inspection control part 20a allows the display part 20b to display the image of the spotting surface of the inspection substrate 3a taken by the image pickup part 19b (step S5). Correspondingly, the display part 20b displays the image of the spotting surface of the inspection substrate 3a. Next, the inspection control part 20a processes the image of the spotting surface of the inspection substrate 3a taken by the image pickup part 19b and judges the presence of a satellite droplet E2 which is smaller than a main droplet E1 of the droplets E and which is incidental to the main droplet E1 (step S6).

For instance, it is executed to binarize the image of the spotting surface of the inspection substrate 3a and further judge whether a black spot representing the satellite droplet E2 is present between pitches of black zone representing the respective droplets E (main droplets E1). If judging the presence of a black spot, then it is judged that there is a satellite droplet E2. While, if judging the absence of a black spot, then it is judged that there is no satellite droplet E2. Alternatively, by binarizing the image of the spotting surface of the inspection substrate 3a, it is executed to calculate respective areas of droplets E (=main droplet E1+satellite droplet E2) and judge whether the area of the main droplet is smaller than a predetermined value. If the calculated area is smaller than the predetermined value, then it is judged that there exists a satellite droplet E2. Conversely, if the calculated area is larger than the predetermined value, then it is judged that there is no satellite droplet E2.

If the inspection control part 20a judges the presence of the satellite droplet E2 (Yes at step S6), it is executed to inform an operator of an occurrence of the satellite droplet E2 (step S7). In detail, for instance, the inspection control part 20a allows the display part 20b to display an image for informing that the satellite droplet E2 has been generated. Correspondingly, the display part 20b displays such an information image representing the occurrence of the satellite droplet E2. On the other hand, if it is judged that there is no satellite droplet E2 (No at step S6), then it is executed to transmit a permissive signal for allowing a droplet jetting of the droplet jetting applicator 1 to the control part 21 (step S8). On receipt of the permissive signal, the control part 21 performs the above-mentioned droplet jetting operation.

When being informed of an occurrence of the satellite droplet E2, the operator recognizes the present situation and takes a variety of measures of (in case that a spotting position of the satellite droplet E2 has an adverse affect on a pattern of droplets): alteration of voltages impressed on the piezoelectric elements 33 of the droplet jetting head 2; replacement of the nozzle plate 35 of the droplet jetting head 2; and replacement of the droplet jetting head 2.

As mentioned above, according to the first embodiment of the present invention, it becomes possible to inspect a plurality of droplets E jetted from the respective nozzles 34 simultaneously by: first taking an image of the inspection area containing an area where the droplets E jetted from the droplet jetting head 2 land in (i.e. an image of the spotting surface of the inspection substrate 3a); processing the image of the spotting surface of the inspection substrate 3a; and judging the presence of a satellite droplet E2 smaller than and incidental to a main droplet E of each droplet E. Accordingly, it is possible to inspect an occurrence of the satellite droplet E2 in a short time. Additionally, as the image of the spotting surface of the inspection substrate 3a is picked up, it is possible to detect a spotting position of each droplet E on the inspection substrate 3a with accuracy. For instance, it is possible to calculate a pitch distance (interval) between the adjoining droplets E, a distance between the main droplet E1 and the satellite droplet E2, etc. with high accuracy.

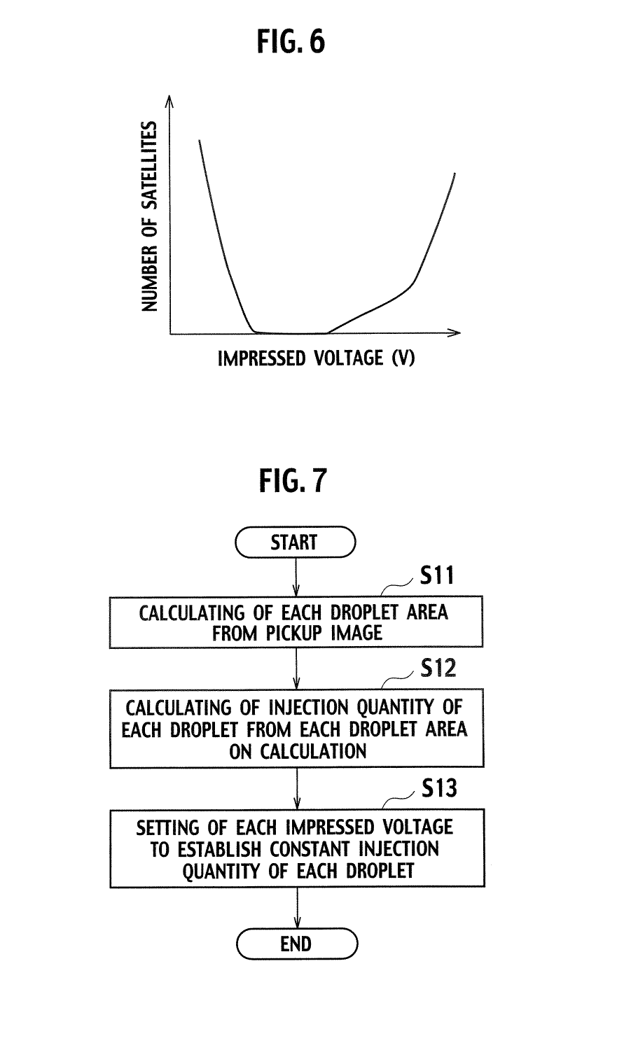

In connection, we did attempt an experiment of allowing the droplet jet inspecting device 18 to jet droplet E while changing voltages impressed on the respective piezoelectric elements 33 in sequence and further counted the number of satellites E2 generated by the experiment. Consequently, as shown in FIG. 6, there is obtained a waveform representing a relationship between the impressed voltage and the number of satellites and also representing a range of impressed voltage providing zero in the number of satellites. Thus, if setting an impressed voltage within this range providing zero in the number of satellites, then it is possible to prevent an occurrence of satellite certainly. Then, the inspection control part 20a sets an impressed voltage within the range providing zero in the number of satellites in accordance with an operator's manipulation for an input part, such as keyboard, connected to the inspection control part 20a. Alternatively, the inspection control part 20a memorizes waveform data as shown in FIG. 6 and further sets an impressed voltage within the range providing zero in the number of satellites, based on the waveform on memory.

Note that when setting an impressed voltage within the range providing zero in the number of satellites, it is necessary to confirm that the so-established impressed voltage is included in the range of voltages capable of attaining a desired jet quantity. Nevertheless, if the impressed voltage is not within the range attaining a desired jet quantity, then there arises a necessity of replacing either the nozzle plates 35 or the droplet jetting heads 2.

Thus, owing to the provision of a voltage adjusting process of: first jetting the droplets in view of detecting the presence of satellite; if detected the presence of a satellite, adjusting the impressed voltage impressed on the piezoelectric elements 33 for jetting droplets; and jetting the droplets again, it is possible to prevent an occurrence of satellites certainly.

### 2^{nd}. Embodiment

The second embodiment of the present invention will be described with reference to FIG. 7.

The second embodiment is basically similar to the first embodiment. In the second embodiment, we now describe its differences with the first embodiment. Additionally, elements identical to those of the first embodiment of the invention will be indicated with the same reference numerals, respectively and their descriptions are eliminated.

FIG. 7 is a flow chart showing an inspecting process performed by the droplet jet inspecting device in accordance with the second embodiment of the present invention.

As shown in FIG. 7, the inspection control part 20a processes an image of an inspection area taken by the image pickup part 19b, namely, an image of the spotting surface (see FIG. 4) of the inspection substrate 3a and further calculates an area (superficial measure) of a droplet E (=main droplet E1+satellite droplet E2) from the above image (step S11). Next, at next step S12, the inspection control part 20a calculates a jet quantity of the droplet E by substituting the so-calculated area of the droplet E into a correlation expression between the area of the droplet E and its droplet quantity, which has been obtained experimentally. Next, at step S13, the inspection control part 20a sets voltages impressed on the piezoelectric elements 33 with respect to each piezoelectric element so that the jet quantities of respective droplets E jetted from the nozzles 34 of the droplet jetting heads 2 become substantially constant.

As mentioned above, according to the second embodiment of the present invention, it is possible to produce effects similar to those of the first embodiment. Additionally, since respective areas of the droplets E are calculated from the image of the inspection area taken by the image pickup part 19b (i.e. the image of the spotting surface of the inspection substrate 3a—see FIG. 4) and successively, the jet quantities of respective droplets E are calculated on the basis of the so-calculated areas, it is possible to obtain the jet quantities of respective droplets E accurately and simultaneously. Thus, the jet quantity of each droplet E can be obtained in a short time. Furthermore, as the jet quantities of the droplets E with respect to each nozzle 34 of the droplet jetting heads 2 become substantially constant by setting voltages impressed on the piezoelectric elements 33 in compliance with the so-calculated jet quantities of the respective droplets E, it is possible to form a pattern of droplets with accuracy.

### Other Embodiments

Note that the present invention is not limited to the above-mentioned embodiments and the invention may be modified variously within a scope of the essence of the present invention.

In common with the previously-mentioned embodiments, for instance, the substrate 3 is moved to the droplet jetting heads 2. However, the invention is not limited to this. For example, the droplet jetting heads 2 may be moved in relation to the substrate 3. Alternatively, the droplet jetting heads 2 and the substrate 3 may be moved relatively.

Again, in the previously-mentioned embodiments, the droplet jet is inspected with the use of the inspection substrate 3a and the mount table 19a. However, the present invention is not limited to this arrangement. For instance, the arrangement may be modified so that the image pickup part 19b is arranged in the ink applicator box 1A to take an image of an inspection area (dummy area) allowing a droplet to land in, while the inspection area is defined in the substrate 3 positioned in the ink applicator box 1A. In this case, it is possible to realize miniaturization of the droplet jetting applicator 1.

Still further, in the previously-mentioned embodiments, when it is judged that a satellite droplet E2 is present, it is performed to display an information image representing a situation that the satellite droplet E2 has been generated. However, the present invention is not limited to this form. Instead, the same information may be presented in the form of sound, a blinking lamp or the like.

What is claimed is:

1. A droplet jet inspecting device comprising:
an image pickup part taking an image of an inspection area including an area where a droplet jetted from a droplet jetting head jetting the droplet through a nozzle; and
a unit configured to process the image of the inspection area taken by the image pickup part and further judge a presence of a satellite droplet which is smaller than a main droplet forming the droplet and which is incidental to the main droplet.

2. The droplet jet inspecting device according to claim 1, further comprising:
a unit configured to calculate an area of the droplet from the image of the inspection area taken by the image pickup part; and
a unit configured to calculate a jet quantity of the droplet, based on the area of the droplet on calculation.

3. A droplet jetting applicator comprising:
a droplet jetting head jetting the drop let through a nozzle; and
a droplet jet inspecting device,
wherein the droplet jet inspecting device includes:
an image pickup part taking an image of an inspection area including an area where a droplet jetted from the droplet jetting head; and
a unit configured to process the image of the inspection area taken by the image pickup part and further judge a presence of a satellite droplet which is smaller than a main droplet forming the droplet and which is incidental to the main droplet.

4. A droplet jetting applicator comprising:
a droplet jetting head jetting the droplet through a nozzle; and
a droplet jet inspecting device,
wherein the droplet jet inspecting device includes:
an image pickup part taking an image of an inspection area including an area where a droplet jetted from the droplet jetting head;
a unit configured to process the image of the inspection area taken by the image pickup part and further judge a presence of a satellite droplet which is smaller than a main droplet forming the droplet and which is incidental to the main droplet;
a unit configured to calculate an area of the droplet from the image of the inspection area taken by the image pickup part; and
a unit configured to calculate a jet quantity of the droplet, based on the area of the droplet on calculation.

5. A method for manufacturing a coated body, comprising:
jetting a droplet to an object to be coated, by a droplet jetting head, the droplet jetting head having a piezoelectric element and being adapted so as to jet the droplet through a nozzle by driving the piezoelectric element;
detecting a presence of a satellite droplet which is incidental to a main droplet forming the droplet; and
adjusting a voltage impressed on the piezoelectric element when the presence of the satellite droplet is detected and subsequently jetting a droplet to the object again.
